(19) United States
(12) Patent Application Publication
(10) Pub. No.: US 2009/0239194 A1
(43) Pub. Date: Sep. 24, 2009

(54) Pliers for use in orthodontics and dentistry

(76) Inventor: Cornelia Fischer-Lokowandt, Pludershausen (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/386,569

(22) Filed: Apr. 20, 2009

Related U.S. Application Data
(63) Continuation-in-part of application No. PCT/EP2006/007713, filed on Sep. 5, 2007.

(30) Foreign Application Priority Data
Oct. 17, 2006 (DE) 10 2006 049 500.4

(51) Int. Cl. A61C 3/14

(52) U.S. Cl. 433/159

(57) ABSTRACT

In a pliers for use in orthodontics and dentistry, comprising pliers halves which are joined by a pivot joint and include operating jaws at one side and handle legs at the opposite side of the pivot joint, wherein the handle legs are provided with cutting edges adjacent the pivot joint and the operating jaws are provided with punching structures for shaping wires, an operating branch is supported by the pivot joint and extends therefrom into the space between the operating jaws and also includes operating surfaces with punching structures corresponding to those on the opposite jaw surfaces.

This is a Continuation-in-Part Application of pending international patent application PCT/EP2007/007713 filed Sep. 5, 2007 and claiming the priority of German patent application 10 2006 049 500.4 filed Oct. 17, 2006.

### BACKGROUND OF THE INVENTION

The present invention resides in a pliers for use in orthodontics and dentistry including two pliers halves joined by a pivot joint and provided, at opposite sides of the joint, with handle levers and operating jaws.

DE 40 06 111 C1 discloses an operating pliers which includes two pivotally joined forceps halves, which include at opposite sides of the pivot joint, handle levers and operating jaws. At the operating jaws, different operating elements are provided, among others, projections and recesses provided at opposite operating surfaces of the two operating jaws, which engage into one another upon closing of the pliers and which emboss a wire disposed between the jaws so as to assume a certain predetermined shape. In this way, wires which are used in orthodontics and dentistry, for example as tooth clamps, can be bent in particular ways as desired. The operating jaws may include a plurality of differently shaped projections and recesses in order to make it possible to establish a relatively large number of different shapes.

A pliers comparable to that disclosed in DE 40 06 111 C1 is described in DE 42 18 458.

U.S. Pat. No. 3,727,316 A also discloses an operating pliers for use in orthodontics and dentistry. The clamping halves of these operating pliers are provided with operating elements including a cutting area which is arranged adjacent to the pivot joint.

In other technical areas, so-called insulation stripping pliers are known, see for example U.S. Pat. No. 4,337,542 A, which are provided at both sides of the central pivot joint with various operating structures disposed at the facing sections of the pliers halves for stripping and cutting insulated wires.

U.S. Pat. No. 3,244,201 discloses a pliers which includes work jaws which are pivotable relative to each other and which, in one embodiment, include an additional operating branch arranged between the pliers jaws. The operating branch is firmly connected to one of the operating jaws by way of an adjustment structure, whereby the distance from the operating jaw is adjustable by a set screw. As a result, the distance between cooperating surfaces of the operating jaws is adjustable by way of the operating branch.

U.S. Pat. No. 3,781,999 discloses a pliers for use by orthodontists comprising two pliers halves which are joined by a pivot joint and the handle legs are provided in the area adjacent the pivot joint with cooperating cutting edges.

Based on this state of the art, it is the object of the present invention to provide pliers for use in orthodontics and dentistry with additional functions without detrimentally affecting the handling capability of the tool.

### SUMMARY OF THE INVENTION

In a pliers for use in orthodontics and dentistry comprising pliers halves which are joined by a pivot joint and include operating jaws at one side and handle legs at the opposite side of the pivot joint, wherein the handle legs are provided with cutting edges adjacent the pivot joint and the operating jaws are provided with punching structures for shaping wires, an operating branch is supported by the pivot joint and extends therefrom into the space between the operating jaws and also includes operating surfaces with punching structures corresponding to those on the opposite jaw surfaces.

The pliers according to the invention can be used not only in the area of its operating jaws for the manipulating of work pieces, but additionally also at the side of the handle legs in an operating area adjacent the pivot joint. This operating area includes at each handle leg a cutting edge so that, upon closing of the pliers, the two cutting edges cooperate for cutting for example a wire disposed therebetween. With the additional operating branch and by relocating the cutting function to the handle side of the pliers, a larger operating area can be provided at the side of the operating jaws which can be used for the installation of various other functions. Overall, the number of the operating functions of the pliers can be increased in this way without detrimentally affecting the handling of the pliers. The cutting of the wire at the two cutting edges in the handle area of the pliers does not involve a more complicated handling in comparison with a cutting area at the operating jaws since the wires used in dentistry are always only short or working occurs only at the end of a wire. The lever conditions are comparable so that the forces for cutting the wires are also about the same.

In an advantageous embodiment, the cutting edges are formed on ledges at the inner side of the handle legs, that is, at the sides of the handle legs which delimit the intermediate handle movement space. The cutting edges are arranged at the opposite side edges of these ledges. By the shape and arrangement of these ledges, an ergonomic operation of the pliers for performing the cutting procedure is obtained as the cutting edges are arranged at an optimum operating angle relative to one another and furthermore the cutting edges engage the wire to be cut at an ergonomically selected angle.

For reducing the possibility of injuries, in an advantageous embodiment of the invention, the cutting edges of the pliers are covered by a cutting edge shielding structure which is arranged at least at one of the handle legs. Preferably, two shielding structures are provided of which one is disposed on each handle leg and both extend in a direction transverse to the longitudinal axis of the pliers and the two protecting shielding structures overlap in a closed as well as open state of the pliers. In this way, unintentional sliding of the hand of the operator into the cutting edge area between the two cutting edges is prevented.

In a preferred embodiment, the operating pliers offer a plurality of functionalities arranged at the operating jaws since the cutting edges are arranged in the area of operating legs. Between the two operating jaws an additional functional branch is arranged in the angular area between the two operating jaws. This functional branch is arranged advantageously in such a way that it is spaced from at least one of the jaws when the pliers are open. Expediently the functional branch is disposed at the same angular distance from the two operating jaws. In this way, an additional functional surface is provided at the functional branch which can be used for the shaping of a work piece. In an advantageous further development the functional branch is in the intermediate area between the two operating jaws not freely movably supported but is coupled to the opening and closing movement of the jaws in order to avoid an additional degree of freedom and to provide for a certain angular space between each of the jaws and the adjacent side of the functional branch when the pliers is open. By means of the functional branch two angular operating areas between the two pliers jaws and the respective functional side at the functional branch can be utilized.

Possibly several functional branches may be arranged between the operating jaws.

Expediently the facing surfaces of the operating jaws and the functional branch form embossment surfaces with projections and/or recesses wherein the projections and recesses at one side cooperate with corresponding recesses and projections at the opposite side. This embodiment can be realized with or without functional branches. With a functional branch present, the overall operating area is increased so that additional variants or embodiments of recesses and projections can be provided. This permits the provision of additional deformation capabilities for example for shaping a wire.

The two operating jaws may have different cross-sections. For example, one jaw may have a triangular cross-section so that the wire to be deformed can be formed accordingly. The second operating jaw then is at its operating side opposite the back side conically pointed with a partially circular cross-section so that the wire can be bent selectively with different radii.

In addition, it may be expedient to arrange at the backside of one or both jaws one or several grooves into which the wire can be placed for bending the wire. If several of such grooves are provided, they extend expediently parallel to one another and transverse to the longitudinal direction of the pliers and particularly at such a distance from one another that the grooves may also be used as measuring structures for determining distances on, or lengths of, a work piece.

The embossing configurations on the functional surfaces of the operating jaws or, respectively, the functional branch can be provided in many ways. It is for example possible that such embossing configurations extend essentially in the longitudinal direction of the operating pliers and are composed of individual sections or segments with only small angular deviations from the longitudinal direction of the pliers. Then a wire can be placed into the recesses and can be deformed with a corresponding embossing plunger structure which is formed on the respective opposite operating surface as a corresponding projection on the functional branch or, respectively, the opposite operating jaw.

Further advantages and expedient embodiments of the invention will become more readily apparent from the following description of the invention on the basis of the accompanying drawings.

### BRIEF DESCRIPTION OF THE DRAWINGS

FIG. 1 is a side view of the pliers according to the invention,

FIG. 2 shows, in an enlarged representation, the backside of an operating jaw with a plurality of parallel grooves wherein a wire to be shaped is shown arranged in one of the grooves,

FIG. 3 is an enlarged view of the functional surface of an operating jaw with a raised stamping structure, and

FIG. 4 shows, similar to FIG. 3, the functional surface area of an operating jaw of a modified embodiment wherein a groove or recess is formed into the projection and a wire is shown disposed in the groove.

### DESCRIPTION OF PARTICULAR EMBODIMENTS

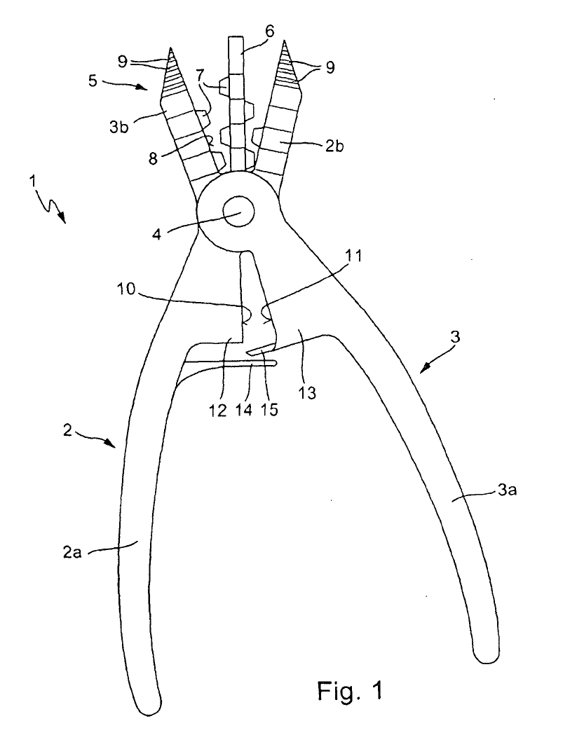

The operating pliers 1 as shown in FIG. 1 is used to process or shape work pieces for example wires which are used in orthodontic procedures and in dentistry. The operating pliers 1 consists of two pliers halves 2, 3, which each is provided with a handle leg 2a and 3a and a working jaw 2b and 3b. Each handle leg and operating jaw of a pliers half is a single piece component. The two pliers halves 2 and 3 are coupled by a pivot joint 4 so as to be pivotable relative to each other. The pivot joint 4 separates the head 5 including the pliers jaws 2b, 3b of the operating pliers from the handle area with the handle legs 2a, 3a.

Between the two operating jaws 2b, 3b, there is a function branch 6 which is also supported via the pivot joint 4 and which extends from the pivot joint 4 radially into the angular area between the operating jaws 2b and 3b. The functional branch 6 divides the operating area between the operating jaws 2b, 3b into two separate areas whereby additional functions can be realized or, respectively, the area available for the application of functional elements can be increased.

The inner sides of the operating jaws 2b and, respectively, 3b are in the form of functional areas with functional parts disposed thereon. Also, the functional branch 6 has surfaces which cooperate with the respective functional surfaces at the inner face areas of the operating jaws. The functional surfaces are provided, in particular with stamping patterns comprising projections 7 and intermediate recesses 8. The stamping or embossment patterns on a functional surface, for example the inner surface of the operating jaw 3b cooperate with the stamping pattern on the facing functional surface of the branch 6. For example, the stamping patterns of facing functional surfaces may be complementary. The functional surfaces at the opposite operating jaws 2b or, respectively, 3b expediently differ from one another in order to have a multitude of different geometries with different stamping patterns.

The functional branch 6 in the operating area between the pliers jaws 2b and 3b has expediently no degree of freedom on its own but is kinematically coupled to the pivot movement of the pliers jaws, so that, upon opening of the pliers, the angular areas between the pliers jaws and the functional branch open up at the same rate. Upon closing of the pliers, the angular areas are also closed at the same rate until the opposite function surface areas of the jaws and the operating branch abut each other.

The two operating jaws 2b, 3b may have different cross-sections. For example, the operating jaw 2b may be triangular in cross-section, particularly in the area next to its tip, whereas the operating jaw 3b has a partial circular cross-section which is delimited by the functional surface and becomes conically smaller toward its tip. Actually, both operating jaws may be provided with a conically narrowing front end but the conical section extends expediently not over the full length of each operating jaw, but is provided only at the outer part and the area adjacent to the tip of the jaws. The section becoming conically smaller toward the tip is preferably provided with several grooves which extend parallel to one another and transverse to the longitudinal direction of the pliers, especially at the backside of the pliers jaws, that is, not on the operating surface of the jaws. Into these grooves, a wire to be shaped may be placed and bent according to the shape of the groove so that for example on the operating jaw of triangular cross-section a correspondingly shaped wire that is a wire section with corners, and on the operating jaw with partially circular cross-section a wire of a correspondingly rounded shape can be formed. By a selection of grooves with different distances from the jaw tip, the radius of the circular section or respectively, the distance between the kinks in the wire can be chosen. The grooves on an operating jaw furthermore may be used as a measuring structure for determining distances or lengths.

In the area of the operating pliers opposite of the head 5, that is in the area of the two handle legs 2a, 3a, cutting edges 10, 11 are formed adjacent the pivot joint 4. Each cutting edge 10, or respectively, 11 is formed at the front edge of a ledge 12 or respectively, 13, which is formed integrally with the handle leg 2a or respectively, 3b and which extends in the direction of the inner space of the handle which is delimited by the two handle legs and transverse to the longitudinal pliers axis. The two cutting edges 10 and 11 cooperate: Upon opening of the pliers, an angular cutting area is opened between the cutting edges 10 and 11 and a wire or similar structure can be inserted to be cut off upon closing of the pliers.

In order to exclude any possibility for injuries, each handle leg 2, 3 is provided with a protective shielding structure 14 or, respectively, 15, which protective shielding structures 14, 15 overlap in every position of the pliers 1 that is also when the pliers is open: In this way, the cutting area between the two cutting edges 10 and 11 is always separated from the handle leg area 2a, 3a. A first protective shielding structure 14 is mounted directly to one handle leg 2a and extends about transversely inwardly. This protective shielding structure 14 is arranged at a small distance from the ledge 12. The second protective shielding structure 15 is shorter than the first protective shielding structure 14 and extends also radially inwardly from the ledge 13 of the second handle leg 3a.

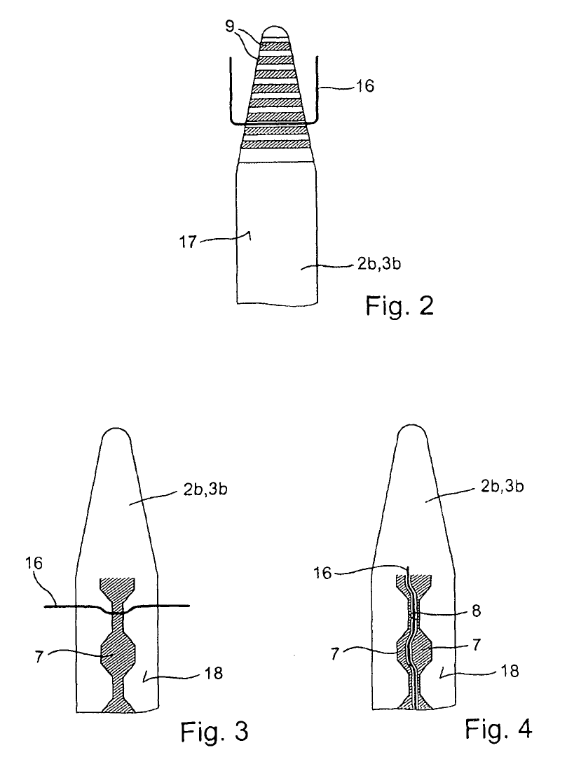

FIG. 2 shows the tip of an operating jaw 2b, 3b in detail. The conical area adjacent the tip is provided at its backside with several parallel grooves into which a wire 16 can be placed to facilitate its bending.

FIG. 3 shows the functional side 18 of an operating jaw 2b, or respectively, 3b. The functional side 18 is provided with a stamping pattern with a projection 7 whose cross-section changes in the longitudinal direction. The wire 16 to be shaped can be placed transverse across the projection 7 so that, upon closing of the pliers, it is pressed into a complementary area on the opposite operating jaw or, respectively, on the functional branch into which the projection is pressed whereby the wire is deformed or shaped accordingly.

FIG. 4 shows a further variant of an operating jaw 2b or, respectively, 3b. The projection 7, which extends in the longitudinal direction, is provided with a recess 8 which forms a groove with several subsequent segments of different angular positions.

The individual segments may extend at a small angle with respect to the longitudinal axis. Into this recess or groove 8, the wire 16 may be placed, which, upon application of a force by a complementarily shaped projection formed on the associated second operating area, deforms the wire according to the course of the groove 8.

What is claimed is:

1. A pliers for use in orthodontics and dentistry comprising two pliers halves (2, 3) pivotally joined via a pivot joint (4) with handle legs (2a, 3a) disposed at one side of the pivot joint (4) and operating jaws (2b, 3b) arranged at the opposite side of the pivot joint (4), the handle legs (2a, 3a) being each provided adjacent the pivot joint (4) with a functional section including cooperating cutting edges (10, 11), a functional branch (6) also supported at the pivot joint (4) and extending therefrom between the two operating jaws (2b, 3b) so that, with the jaws (2b, 3b) open, the operating branch (6) is disposed in spaced relationship from the operating jaws (2b, 3b), the surface areas of the functional branch (6) opposite the pliers jaws (2b, 3b) each having a punching area with at least one of projection (7) and recesses (8) cooperating with corresponding recesses (8) any projections (7) on the opposite jaw surfaces.

2. The pliers according to claim 1, wherein the cutting edges (10, 11) are provided on ledges (12, 13) formed on the handle legs (2a, 3a) and extending inwardly in the direction toward each other so as to form the cutting edges (10, 11),

3. The pliers according to claim 1, wherein the cutting edges (10, 11) are covered by protective shielding structures (14, 15) formed at at least one of the handle legs (2a, 3a) so as to cover the cutting edges (10, 11).

4. The pliers according to claim 1, wherein on each handle leg (2a, 3a) a protective shielding structure (14, 15) is arranged in such a way that the shielding structures (14, 15) partially overlap when the pliers is closed and when it is open.

5. The pliers according to claim 1, wherein the functional branch (6) is kinematically coupled with the pliers halves (2, 3) such that, upon opening of the pliers halves (2, 3), the functional branch (6) assumes a predetermined angle relative to the operating jaws (2b, 3b).

6. The pliers according to claim 1, wherein the operating jaws (2b, 3b) have a shape narrowing down conically toward their tips.

7. The pliers according to claim 1, wherein on the opposite sides of the functional branch (6) different punching surface areas with projections (7) and recesses (8) are provided.

8. The pliers according to claim 1, wherein one of the operating jaws (2b, 3b) has a triangle-shaped cross-section.

9. The pliers according to claim 1, wherein the functional surfaces of the operating jaws (2b, 3b) facing each other are provided punching patterns including recesses (8) and projections (7).

10. The pliers according to claim 9, wherein at least one of the operating jaws (2b, 3b) is provided with a punching pattern extending in the longitudinal direction of the jaw (2b, 3b).

11. The pliers according to claim 9, wherein at least one of the operating jaws (2b, 3b) is provided with a punching pattern extending in a direction transverse to the longitudinal extension of the jaws (2b, 3b).

12. The pliers according to claim 1, wherein the backside of at least one of the operating jaws (2b, 3b) is provided with several grooves (9).
